(19) United States
(12) Patent Application Publication
(10) Pub. No.: US 2011/0193815 A1
(43) Pub. Date: Aug. 11, 2011

(54) TOUCH PANEL

(75) Inventors: Koji Tanabe, Osaka (JP); Shoji Fujii, Osaka (JP); Hideo Iguchi, Osaka (JP)

(73) Assignee: Panasonic Corporation, Osaka (JP)

(21) Appl. No.: 12/935,944

(22) PCT Filed: Feb. 19, 2009
(86) PCT No.: PCT/JP2009/000690

§ 371 Date: Oct. 1, 2010

(30) Foreign Application Priority Data
May 16, 2008 (JP) 2008-129391
Dec. 1, 2008 (JP) 2008-305991

(51) Int. Cl. G06F 3/045

(52) U.S. Cl. 345/174

(57) ABSTRACT

A touch panel includes a light-transmittable upper board, a light-transmittable upper resistive layer provided on a lower surface of the upper board, a light-transmittable lower resistive layer having an upper surface facing a lower surface of the upper resistive layer with a predetermined gap, a light-transmittable lower board provided on a lower surface of the lower resistive layer, plural conductive particles provided on at least one of the lower surface of the upper resistive layer and the upper surface of the lower resistive layer, and a transparent resin portion for fixing the conductive particles to the at least one of the lower surface of the upper resistive layer and the upper surface of the lower resistive layer. Upon having a display element provided on a lower surface of the lower board, this touch panel allows the display element to be easily visually recognized, and is inexpensive and operated easily.

### TECHNICAL FIELD

The present invention relates to a touch panel used to operate various electronic devices.

### BACKGROUND ART

Various electronic devices, such as mobile phones and car navigations have recently had various functions. Such an electronic device may include a display element, such as a liquid crystal display element, is attached with a light transmittable touch panel on a front surface of the display element. An operator presses the touch panel with a finger or a pen while visually recognizing a screen of the display element behind this touch panel to switch various functions of the device. This touch panel is required to have the operator to easily view the screen of the display element behind of the touch panel and to be operated easily.

FIG. 6 is a cross-sectional view of conventional touch panel 501 disclosed in Patent Literature 1.Upper board 101 is made of flexible film of light-transmittable material. Lower board 2 is made of light-transmittable material, such as glass. Upper resistive layer 103 made of light-transmittable resistive material, such as indium tin oxide, is provided on lower surface 101B of upper board 101. Lower resistive layer 4 made of light-transmittable resistive material, such as indium tin oxide, is provided on upper surface 2A of lower board 2.

Dot spacers 51 made of insulating resin are provided on upper surface 4A of lower resistive layer 4 with predetermined intervals between the spacers. A pair of upper electrodes are provided on both ends of upper resistive layer 103. A pair of lower electrodes are provided on both ends of lower resistive layer 4 and arranged in a direction perpendicular to a direction in which the upper electrodes are arranged.

Spacer 5 has a substantially frame shape. Spacer 5 is provided between upper board 101 and lower board 2 along outer peripheries of upper board 101 and lower board 2. An upper surface and a lower surface of spacers 5 are adhered with adhesive agent to the outer periphery of upper board 101 and the outer periphery of lower board 2, respectively Lower surface 103B of upper resistive layer 103 faces upper surface 4A of lower resistive layer 4 with a predetermined gap between the surfaces.

Touch panel 501 is installed into an electronic device such that lower surface 2B of lower board 2 is placed on screen 61A of display element 61, such as a liquid crystal display and the upper and lower electrodes are connected to an electronic circuit of the electronic device.

The operator visually recognizes screen 61A of display element 61 through touch panel 501 and depresses upper surface 101A of upper board 101 with, e.g. a finger or a pen. Upon being depressed, upper board 101 warps to cause the depressed portion of upper resistive layer 103 to contact lower resistive layer 4. A voltage is applied from the electronic circuit between the upper electrodes and between the lower electrodes sequentially The electronic circuit detects the position of the depressed portion based on a ratio of voltages between these electrodes, and switches various functions of the electronic device.

Upon being depressed, upper board 101 warps downward to reduce the gap between upper resistive layer 103 and lower resistive layer 4. When this interval becomes small, e.g. smaller, than 10 μm, the waping portion is surrounded by a Newton ring that is an interference pattern caused by reflection of ambient light, preventing the operator from visually recognize screen 61A through touch panel 501 easily.

Upper surface 2A of lower board 2 may be roughed by being etched with, e.g. hydrofluoric acid. Lower resistive layer 4 is provided on roughened upper surface 2A to reduce the Newton ring. However, the roughening process requires time and cost, accordingly causing touch panel 501 to be expensive.

Patent Literature 1: JP2007-65982A

### SUMMARY OF THE INVENTION

A touch panel includes a light-transmittable upper board, a light-transmittable upper resistive layer provided on a lower surface of the upper board, a light-transmittable lower resistive layer having an upper surface facing a lower surface of the upper resistive layer with a predetermined gap, a light-transmittable lower board provided on a lower surface of the lower resistive layer, plural conductive particles provided on at least one of the lower surface of the upper resistive layer and the upper surface of the lower resistive layer, and a transparent resin portion for fixing the conductive particles to the at least one of the lower surface of the upper resistive layer and the upper surface of the lower resistive layer.

Upon having a display element provided on a lower surface of the lower board, this touch panel allows the display element to be easily visually recognized, and is inexpensive and operated easily.

### BRIEF DESCRIPTION OF THE DRAWINGS

FIG. 1A is a top view of a touch panel according to Exemplary Embodiment 1 of the present invention.

FIG. 1B is a cross-sectional view of the touch panel on line 1B-1B shown in FIG. 1A.

FIG. 1C is a cross-sectional view of the touch panel on line 1C-1C shown in FIG. 1A.

FIG. 1D is a cross-sectional view of another touch panel according to Embodiment 1.

FIG. 1E is a cross-sectional view of still another touch panel according to Embodiment 1.

FIG. 2 is a cross-sectional view of a touch panel according to Exemplary Embodiment 2 of the invention.

FIG. 3A is a cross-sectional view of a touch panel according to exemplary Embodiment 3 of the invention.

FIG. 3B is a cross-sectional view of the touch panel on line 3B-3B shown in FIG. 3A.

FIG. 3C is a cross-sectional view of the touch panel on line 3C-3C shown in FIG. 3A.

FIG. 4A is a circuit diagram of the touch panel according to Embodiment 3.

FIG. 4B is a circuit diagram of the touch panel according to Embodiment 3.

FIG. 4C is a circuit diagram of the touch panel according to Embodiment 3.

FIG. 5 illustrates characteristics of the touch panel according to Embodiment 3.

FIG. 6 is a cross-sectional view of a conventional touch panel.

### REFERENCE NUMERALS

4 Lower Resistive Layer
2 Lower Board
7 Conductive Particle (First Conductive Particle)
8 Transparent Resin Portion
9 Transparent Particle
7A Conductive Particle (Second Conductive Particle)
101 Upper Board
103 Upper Resistive Layer

### DETAILED DESCRIPTION OF PREFERRED EMBODIMENTS

### Exemplary Embodiment 1

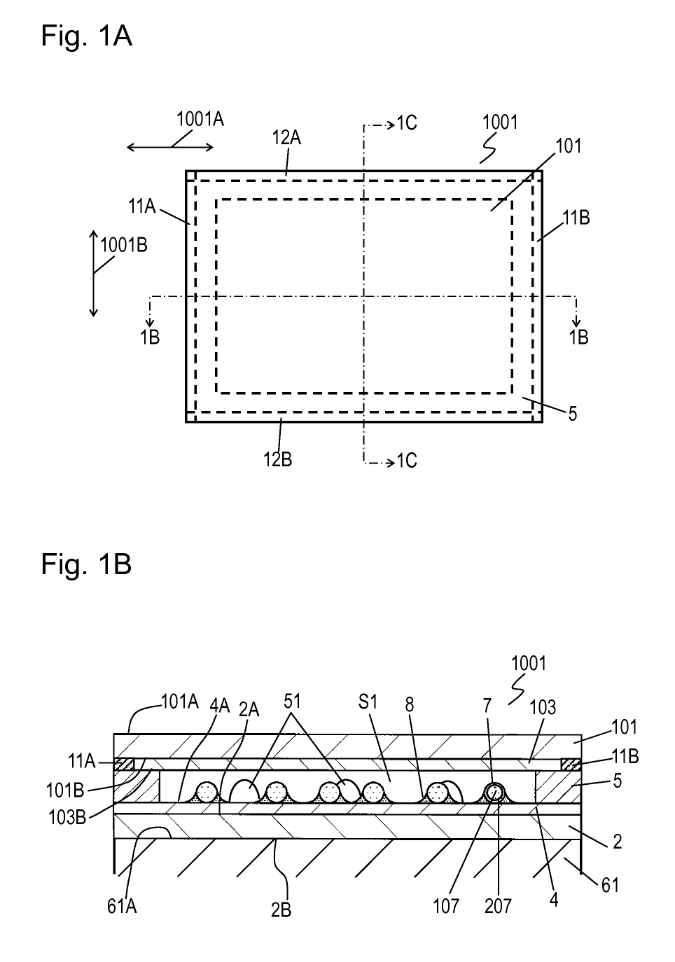

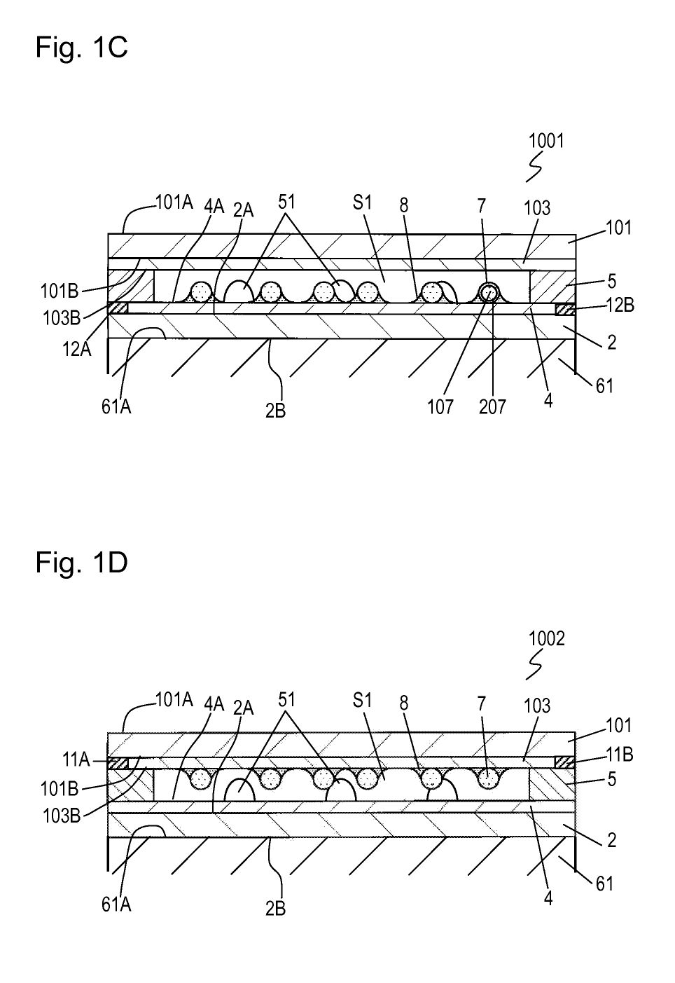

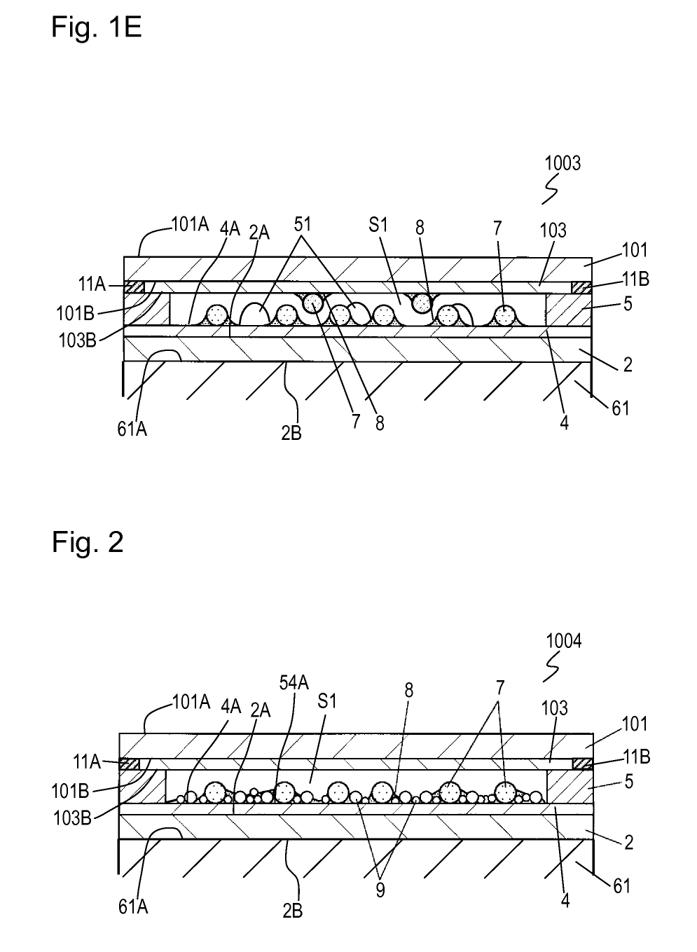

FIG. 1A is a top view of touch panel 1001 according to Exemplary Embodiment 1 of the present invention. FIG. 1B is a cross-sectional view of touch panel 1001 on line 1B-1B shown in FIG. 1A. FIG. 1C is a cross-sectional view of touch panel 1001 on line 1C-1C shown in FIG. 1A. Upper board 101 is made of flexible light-transmittable material, such as polyethersulfone, polycarbonate, or glass. Lower board 2 is made of light-transmittable material, such as glass, acrylic, or polycarbonate. Upper resistive layer 103 made of light-transmittable resistive material, such as indium tin oxide or tin oxide, is provided on lower surface 101B of upper board 101 by, e.g. sputtering. Lower resistive layer 4 made of light-transmittable resistive material, such as indium tin oxide or tin oxide, is provided on upper surface 2A of lower board 2 by, e.g. sputtering.

Each of conductive particles 7 has a particle diameter ranging from about 1 to 20 μm and is fixed to upper surface 4A of lower resistive layer 4 with transparent resin portion 8 made of transparent resin, such as acrylic resin, epoxy resin, silicone resin, fluorine-based resin, polythiophene-based resin, polyaniline-based resin, or polypyrrole-based resin. Conductive particle 7 and transparent resin portion 8 is located away from lower surface 103B of upper resistive layer 103 with a gap. Conductive particle 7 has a particle diameter ranging from about 1 to 20 μm. Conductive particle 7 includes core 107 and plated layer 207 covering core 107. Core 107 is made of, e.g. benzoguanamine or acrylic. Plated layer 207 is made of metal, such as gold, silver, rhodium, platinum, palladium, or nickel. Conductive particle 7 may include a core particle and conductive powder dispersed to surround the core particle. The core particle is made of, e.g. silicone rubber or elastomer. The Conductive powder is made of carbon, indium tin oxide, or silver. Conductive particle 7 may be made of metal. Alternatively, conductive particle 7 may be a particle containing conductive resin, such as conductive polymer, such as polythiophene.

A predetermined number of conductive particles 7 are dispersed in solution obtained by dissolving transparent resin which is the material of transparent resin portion 8 to prepare disperse solution. This disperse solution can be blown to or printed on upper surface 4A of lower resistive layer 4 to fix conductive particles to upper surface 4A of lower resistive layer 4 easily.

Dot spacers 51 made of insulating resin, such as epoxy or silicone, are provided on upper surface 4A of lower resistive layer 4 with predetermined intervals between the spacers. Upper electrodes 11A and 11B made of conductive material, such as silver or carbon, are provided at both ends of upper resistive layer 103 in direction 1001A, and are connected to upper resistive layer 103. Upper electrodes 11A and 11B are arranged in direction 1001A. Lower electrodes 12A and 12B are provided ay both ends of lower resistive layer 4 in direction 1001B perpendicular to direction 1001A, and are connected to lower resistive layer 4. Lower electrodes 12A and 12B are arranged in direction 1001B.

Spacer 5 made of insulating material, such as polyester, epoxy, or non-woven fabric, ix provided between upper board 101 and lower board 2. Spacer 5 is provided at an outer periphery of upper board 101 and an outer periphery of lower board 2, and has a substantially frame shape. Spacer 5 is fixed with adhesive agent, such as acrylic or rubber, onto the outer periphery of upper board 101 and the outer periphery of lower board 2. Lower surface 103B of upper resistive layer 103 faces upper surface 4A of lower resistive layer 4 with a predetermined gap ranging from about 5 to 100 μm to provide space S1 between the upper and lower surfaces.

Lower surface 2B of lower board 2 is placed on screen 61A of display element 61, such as a liquid crystal display. Touch panel 1001 is installed to the electronic device. Upper electrodes 11A and 11B and lower electrodes 12A and 12B are electrically connected to an electronic circuit of the electronic device.

An operation of touch panel 1001 will be described below. An operator depresses upper surface 101A of upper board 101 with a finger or a pen while visually recognizing screen 61A of display element 61 through touch panel 1001, thereby causing upper board 101 to warp downward toward lower board 2. Then, a portion of lower surface 103B of upper resistive layer 103 corresponding to the depressed portion of upper board 101 contacts conductive particles 7, thus connecting upper resistive layer 103 with lower resistive layer 4 via conductive particles 7.

Then, a voltage is applied from the electronic circuit between upper electrodes 11A and 11B and between lower electrodes 12A and 12B sequentially. The electronic circuit detects the position of the depressed portion based on voltages between upper electrodes 11A and 11B and between electrodes 12A and 12B to switch various functions of the electronic device.

Upper board 101 warps downward to reduce the gap between upper resistive layer 103 and lower resistive layer 4. Upper resistive layer 103 is connected with lower resistive layer 4 via conductive particles 7. The gap between upper resistive layer 103 and lower resistive layer 4 cannot be smaller than the diameter of conductive particle 7, thus suppressing the Newton ring caused by the reflection of ambient light. Therefore, the operator can visually recognize screen 61A of display element 61 easily through touch panel 1001 to operate touch panel 1001 reliably.

As described above, conductive particles 7 are fixed to upper surface 4A of lower resistive layer 4 by a simple method, such as blowing or printing, hence allowing touch panel 1001 from being manufactured inexpensively.

Conductive particles 7 reduce the warping of upper board 101 during the depression, allowing the operator from operating touch panel 1001 with a light force.

Conductive particles 7 having an excessively small diameter reduce the effect as described above of reducing the Newton ring. Conductive particles 7 having an excessively large diameter, on the other hand, cause conductive particles 7 to be visually recognized, thus suppressing the visibility of screen 61A of display element 61. Therefore, conductive particle 7 preferably has a particle diameter ranging from about 1 to 20 μm, more preferably from about 3 to 10 μm.

FIG. 1D is a cross-sectional view of another touch panel 1002 according to Embodiment 1. In FIG. 1D, components identical to those of touch panel 1001 shown in FIG. 1B are denoted by the same reference numerals, and their description will be omitted. In touch panel 1002 shown in FIG. 1D, conductive particles 7 are fixed with transparent resin portion 8 to lower surface 103B of upper resistive layer 103, providing the same effect as that of touch panel 1001 shown in FIG. 1B.

FIG. 1E is a cross-sectional view of still another touch panel 1003 according to Embodiment 1. In FIG. 1E, components identical to those of touch panel 1001 shown in FIG. 1B are denoted by the same reference numerals, and their description will be omitted. In touch panel 1003 shown in FIG. 1E, conductive particles 7 are fixed with transparent resin portion 8 to both of upper surface 4A of lower resistive layer 4 and lower surface 103B of upper resistive layer 103, thus providing the same effect as that of touch panel 1001 shown in FIG. 1B.

Specifically, in touch panels 1001 to 1003 according to Embodiment 1,conductive particles 7 are fixed with transparent resin portion 8 to at least one of upper surface 4A of lower resistive layer 4 and lower surface 103B of upper resistive layer 103, thus providing the same effect.

### Exemplary Embodiment 2

FIG. 2 is a cross-sectional view of touch panel 1004 according to Exemplary Embodiment 2 of the present invention. In FIG. 2, components identical to those of touch panel 1001 shown in FIGS. 1A and 1B are denoted by the same reference numerals, and their description will be omitted.

Touch panel 1004 shown in FIG. 2 further includes transparent. particles 9 dispersed in transparent resin portion 8. Transparent particles 9 are made of transparent material, such as glass or insulating resin, and have a diameter ranging from about 0.5 to 2 μm smaller than that of conductive particle 7.

Transparent resin portion 8 has a lower refractive index than upper resistive layer 103 and lower resistive layer 4. According to Embodiment 2, upper resistive layer 103 and lower resistive layer 4 have a refractive index of 1.9. Transparent resin portion 8 is made of insulating resin, such as acrylic, epoxy, silicone, or fluorine-based resin or of conductive resin, such as polythiophene-based resin, polyaniline-based resin, or polypyrrole-based resin. Transparent resin portion 8 has a refractive index ranging from 1.1 to 1.5. Transparent resin portion 8 covers the entire surface of portion 54A of upper surface 4A of lower resistive layer 4 facing space S1. Lower surface 103B of upper resistive layer 103 faces a surface having micro asperities thereon that is formed by transparent resin portion 8 containing conductive particles 7 and transparent particles 9 dispersed therein.

Solution containing transparent resin dissolved therein and a predetermined number of conductive particles 7 and transparent particles 9 dispersed therein is prepared. The transparent resin forms transparent resin portion 8. The solution is blown to or printing on upper surface 4A of lower resistive layer 4, thereby easily coating upper surface 4A of lower resistive layer 4 with transparent resin portion 8.

In touch panel 1004, the entire surface of portion 54A of upper surface 4A of lower resistive layer 4 is covered with transparent resin portion 8 having a low refractive index, thus reducing reflection of ambient light. In other words, ambient light transmitting through upper board 101 and entering into space S1 between upper resistive layer 103 and lower resistive layer 4 is reflected not on upper surface 4A of lower resistive layer 4 having a high refractive index but on an upper surface of transparent resin portion 8 having a low refractive index. This prevents the ambient light from reflecting upward. Thus, an operator can visually recognize screen 61A of display element 61 easily through touch panel 1001.

Transparent resin portion 8 has a lower refractive index than upper resistive layer 103 and lower resistive layer 4. The upper surface of the transparent resin portion has micro asperities thereon formed with transparent particles 9 having a smaller diameter than dispersed conductive particles 7. This arrangement causes the ambient light entering into space S1 to be diffusely reflected on transparent resin portion 8, thus preventing a Newton ring from occurring.

Specifically, in touch panel 1004 according to Embodiment 2, upper resistive layer 103 is connected securely with lower resistive layer 4 via conductive particles 7. Transparent resin portion 8 containing transparent particles 9 dispersed therein and having the surface having the micro asperities reduces a Newton ring. The operator can visually recognize screen 61A of display element 61 easily through touch panel 1004, accordingly operating touch panel 1004 easily.

As described along touch panels 1002 and 1003 shown in FIGS. 1D and 1E, transparent resin portion 8 containing conductive particles 7 and transparent particles 9 dispersed therein may be provided on at least one of upper surface 4A of lower resistive layer 4 and lower surface 103B of upper resistive layer 103, providing the same effect.

### Exemplary Embodiment 3

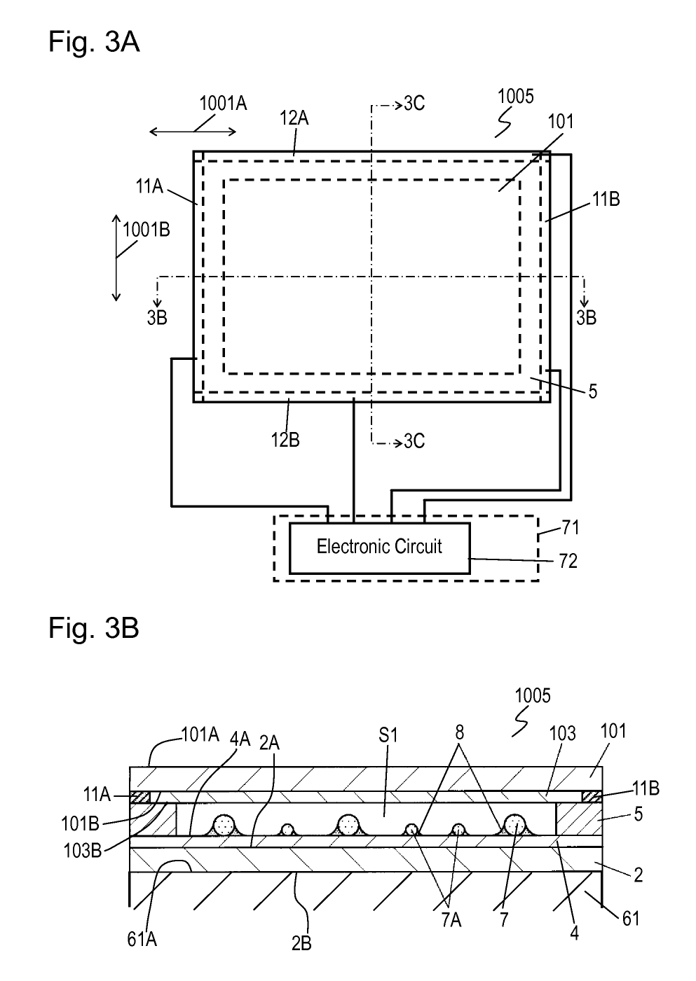

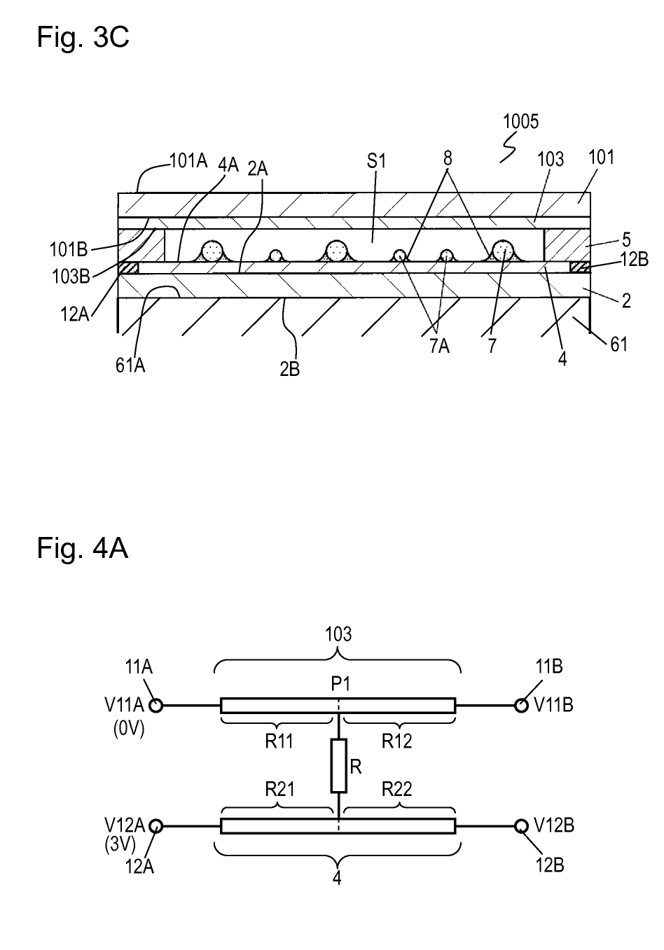

FIG. 3A is a top view of touch panel 1005 according to Exemplary Embodiment 3 of the present invention. FIG. 3B is a cross-sectional view of touch panel 1005 on line 3B-3B shown in FIG. 3A. FIG. 3C is a cross-sectional view of touch panel 1005 on line 3C-3C shown in FIG. 3A. In FIGS. 3A to 3C, components identical to those of touch panel 1001 according to Embodiment 1 shown in FIGS. 1A to 1C are denoted by the same reference numerals, and their description will be omitted.

Touch panel 1005 according to Embodiment 3 further includes conductive particles 7A fixed with transparent resin portion 8 to upper surface 4A of lower resistive layer 4 in addition to touch panel 1001 according to Embodiment 1 shown in FIGS. 1B and 1C. Conductive particle 7A has a smaller diameter than conductive particle 7, a diameter ranging from about 1 to 3 μm according to Embodiment 3.

Conductive particles 7 and 7A can be easily fixed to upper surface 4A of lower resistive layer 4 by blowing or printing solution onto upper surface 4A of lower resistive layer 4. The solution contains transparent resin dissolved therein and a predetermined number of dispersed conductive particles 7 and 7A dispersed therein. The transparent resin forms transparent resin portion 8.

Lower surface 2B of lower board 2 is adapted to be placed on screen 61A of display element 61 such as a liquid crystal display. Touch panel 1005 is installed into electronic device 71. Upper electrodes 11A and 11B and lower electrodes 12A and 12B are electrically connected to electronic circuit 72 of electronic device 71.

An operation of touch panel 1005 will be described below. An operator depresses upper surface 101A of upper board 101 with a finger or a pen while visually recognizing the display of screen 61A of display element 61 through touch panel 1005, thereby causing upper board 101 to warp downward toward lower board 2. Then, a portion of lower surface 103B of upper resistive layer 103 corresponding to depressed portion P1 of upper board 101 contacts conductive particles 7, thus connecting upper resistive layer 103 with lower resistive layer 4 via conductive particles 7.

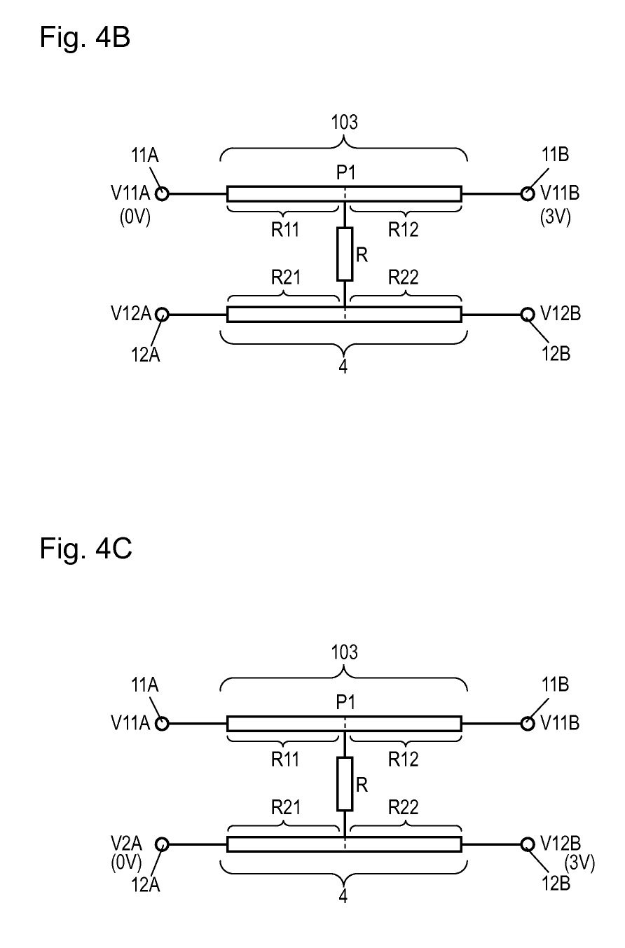

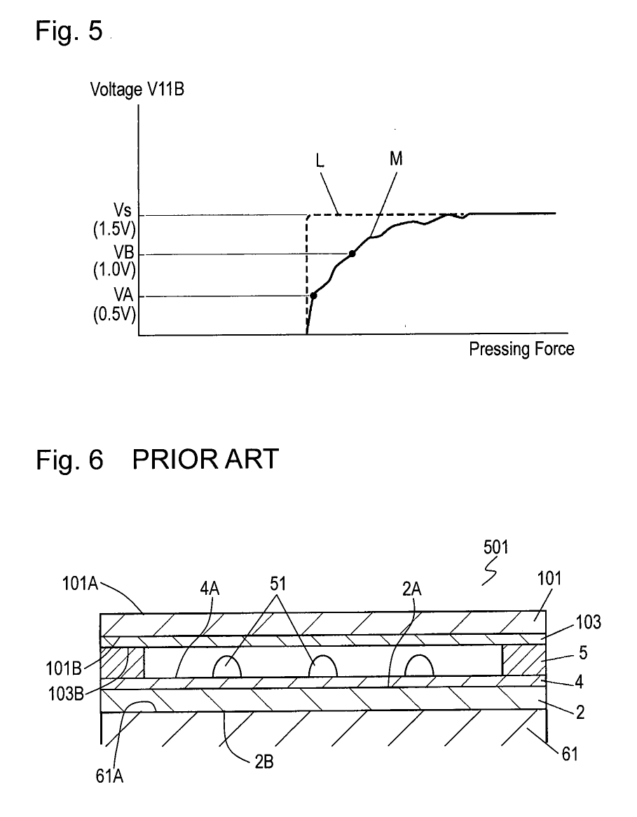

FIGS. 4A to 4C are circuit diagrams of touch panel 1005. FIG. 5 illustrates voltages detected by electronic circuit 72. Electronic circuit 72 can apply voltages V11A, V11B, V12A, and V12B to electrode 11A, 11B, 12A, and 12B, respectively, and can detect these voltages. Resistors R11 and R12 represent upper resistive layer 103. Resistors R21 and R22 represent lower resistive layer 4.

Upon having portion P1 depressed by the operator with a small depressing force, lower surface 103B of upper resistive layer 103 first contacts conductive particles 7 having a large diameter, but does not contact conductive particles 7A to be away from conductive particles 7A, hence providing resistance R between upper resistive layer 103 and lower resistive layer 4 with a large value. As shown in FIG. 4A, for example, electronic circuit 72 sets voltage V11A and voltage V12A to 0V and 3V, respectively. In this case, voltage V11B at upper electrode 11B detected by electronic circuit 72 becomes voltage VA of about 0.5V which is closer to voltage V11A than voltage V12A is, as shown in FIG. 5.

Then, the depressing force, upon increasing, causes lower surface 103B of upper resistive layer 103 to contact not only conductive particles 7A near conductive particles 7 but also conductive particles 7A, accordingly reducing resistance value R. Thus, voltage V11B of upper electrode 11B detected by electronic circuit 72 changes from voltage VA to voltage VB of about 1V close to voltage V12A.

The depressing force, upon further increasing, causes lower surface 103B of upper resistive layer 103 to contact a larger number of conductive particles 7 and 7A and to contact lower resistive layer 4 at a larger contact area. This reduces resistance R and causes voltage V11B detected by electronic circuit 72 to be closer to voltage V12A, finally causing voltage V11B to be saturation voltage Vs of about 1.5V.

In other words, the upper surface of upper board 101 is depressed for operation, and changes resistance R between resistive layer 103 and lower resistive layer 4 from a larger value to a smaller value according to the increase of the depressing force. In accordance with the change, the detected voltage changes not along curve L that rapidly changes to saturation voltage Vs but along curve M that gradually changes to saturation voltage Vs depending on the depressing force.

Then, electronic circuit 72 switches, as shown in FIG. 4B, to apply voltage V11A of 0V to upper electrode 11A and to apply voltage V11B of 3V to upper electrode 11B. While applying voltages V11A and V11B, electronic circuit 72 detects voltage V12A of lower electrode 12A or voltage V12B of lower electrode 12B to detect the position of the position of the depressed portion P1 of upper surface 101A of upper board 101 in direction 1001A.

Them, electronic circuit 72 switches, as shown in FIG. 4C, to apply voltage V12A of 0V to lower electrode 12A and to apply voltage V12B of 3V to lower electrode 12B. While applying voltages V12A and V12B, electronic circuit 72 detects voltage V11A of upper electrode 11A or voltage V11B of upper electrode 11B to detect the position of the depressed portion P1 of upper surface 101A of upper board 101 in direction 1001B.

As described above, electronic circuit 72 detects the position of the depressed part P1 in directions 1001A and 1001B perpendicular to each other, thus detecting two-dimensional coordinates of the depressed portion P1. Electronic circuit 72 switches various functions of electronic device 71 based on the detected coordinates

While upper board 101 is depressed to change the voltages of electrodes 11A, 11B, 12A, and 12B to saturation voltage Vs of, e.g. about 1.5V, the voltage changes gradually according to the depressing force. This change can be used to operate electronic device 71 as described below. Specifically, electronic circuit 72 detects saturation voltage Vs and the voltage gradually changing. When the operator lightly touches upper surface 101A of upper board 101 while nothing is displayed on screen 61A of display element 61, electronic circuit 72 detects that the voltages of electrodes 11A. 11B, 12A, and 12B are lower than saturation voltage Vs, and displays a menu including plural options on display element 61. Then, the operator depresses, with a finger with a depressing force gradually increasing, a portion of upper surface 101A of upper board 101 corresponding to a position at which a desired option is displayed. The voltages of electrodes 11A, 11B, 12A, and 12B accordingly change to saturation voltage Vs. Then, electronic circuit 72 detects that the voltages of electrodes 11A, 11B, 12A, and 12B becomes saturation voltage Vs, detects the position of the depressed portion P1, and controls electronic device 71 according to the option.

Alternatively, when the operator lightly touches upper surface 101A of upper board 101 while a menu including plural options, such as a telephone number, an address or a title of a song, displayed on display element 61, the menu is advanced to other menus sequentially. When the operator still depresses upper board 101 with a larger depressing force, electronic circuit 72 can fast-forward or fast-reverse plural menus on display element 61 at a predetermined speed to display the menus.

In Embodiments 1 to 3, terms indicating directions, such as “upper surface” and “lower surface”, represent a relative direction depending only upon relative positional relationship among components of touch panels 1001 to 1005, such as upper board 101, lower board 2, upper resistive layer 103, and lower resistive layer 4, and do not represent an absolute direction, such as a vertical direction.

### INDUSTRIAL APPLICABILITY

A touch panel according to the present invention allows an operator to visually recognize a display element easily This touch panel is inexpensive and is easy to operate, thus being useful to operate an electronic device.

1. A touch panel comprising:
a light-transmittable upper board;
a light-transmittable upper resistive layer provided on a lower surface of the upper board;
a light-transmittable lower resistive layer having an upper surface facing a lower surface of the upper resistive layer with a predetermined gap between the lower resistive layer and the lower surface of the upper resistive layer;
a light-transmittable lower board provided on a lower surface of the lower resistive layer;
a plurality of first conductive particles provided on at least one of the lower surface of the upper resistive layer and the upper surface of the lower resistive layer; and
a transparent resin portion for fixing the plurality of first conductive particles to the at least one of the lower surface of the upper resistive layer and the upper surface of the lower resistive layer.

2. The touch panel according to claim 1, further comprising a plurality of transparent particles dispersed in the transparent resin portion, the plurality of transparent particles having diameters smaller than diameters of the plurality of first conductive particles.

3. The touch panel according to claim 1, further comprising a plurality of second conductive particles provided on at least one of the lower surface of the upper resistive layer and the upper surface of the lower resistive layer, the plurality of second conductive particles having diameters smaller than diameters of the plurality of first conductive particles.

4. The touch panel according to claim 1, further comprising :
first and second upper electrode provided at both ends of the upper resistive layer;
first and second lower electrode provided at both ends of the lower resistive layer; and
an electronic circuit connected to the first and second upper electrode and the first and second lower electrode, the electronic circuit being operable to
detect a voltage of one of the second upper electrode and the second lower electrode while applying a voltage between the first upper electrode and the first lower electrode while a portion of the upper board is depressed, and
execute a predetermined operation when the detected voltage becomes a predetermined voltage.

5. The touch panel according to claim 4, wherein the electronic circuit is operable to detect the depressed portion of the upper board when the detected voltage becomes the predetermined voltage.

6. The touch panel according to claim 1, further comprising:
first and second upper electrode provided at both ends of the upper resistive layer;
first and second lower electrode provided at both ends of the lower resistive layer; and
an electronic circuit connected to the first and second upper electrode and the first and second lower electrode, the electronic circuit being operable to
detect a voltage of one of the second upper electrode and the second lower electrode while applying a voltage between the first upper electrode and the first lower electrode while a portion of the upper board is depressed, and
execute a predetermined operation when the detected voltage becomes a predetermined voltage.

7. The touch panel according to claim 6, wherein the electronic circuit is operable to detect the depressed portion of the upper board when the detected voltage becomes the predetermined voltage.

8. The touch panel according to claim 1, further comprising:
first and second upper electrode provided at both ends of the upper resistive layer;
first and second lower electrode provided at both ends of the lower resistive layer; and
an electronic circuit connected to the first and second upper electrode and the first and second lower electrode, the electronic circuit being operable to
detect a voltage of one of the second upper electrode and the second lower electrode while applying a voltage between the first upper electrode and the first lower electrode while a portion of the upper board is depressed, and
execute a predetermined operation when the detected voltage becomes a predetermined voltage.

9. The touch panel according to claim 8, wherein the electronic circuit is operable to detect the depressed portion of the upper board when the detected voltage becomes the predetermined voltage.

10. The touch panel according to claim 1, wherein the transparent resin portion has a refractive index smaller than a refractive index of the upper resistive layer.

11. The touch panel according to claim 11, wherein the transparent resin portion has the refractive index smaller than a refractive index of the lower resistive layer.

12. The touch panel according to claim 1, wherein the transparent resin portion has a refractive index smaller than a refractive index of the lower resistive layer.
